(19) United States
(12) Patent Application Publication
(10) Pub. No.: US 2024/0169556 A1
(43) Pub. Date: May 23, 2024

(54) Sensor Fusion System And Method Of Managing Track In Sensor Fusion System

(71) Applicants: Hyundai Motor Company, Seoul (KR); Kia Corporation, Seoul (KR)

(72) Inventors: So Yeon Jeon, Busan (KR); Woo Young Lee, Seoul (KR); Dong Joo Lee, Seongnam-Si (KR)

(21) Appl. No.: 18/515,725

(22) Filed: Nov. 21, 2023

(30) Foreign Application Priority Data
Nov. 21, 2022 (KR) 10-2022-0156198

(51) Int. Cl. G06T 7/20

(52) U.S. Cl. CPC G06T 7/20; G01S 17/89; G06T 2207/10028; G06T 2207/30261

(57) ABSTRACT

A method for operating a vehicle is introduced. The method may comprise detecting, based on sensing information from one or more sensors of the vehicle, track information associated with an object, and determining a management index of the track information based on at least one of a maintenance time of the track information associated with an amount of time the object has been tracked, an accuracy of information from the one or more sensors, or a risk of collision between the vehicle and the object.

This application claims the benefit of Korean Patent Application No. 10-2022-0156198, filed on Nov. 21, 2022, which is hereby incorporated by reference as if fully set forth herein.

### TECHNICAL FIELD

The present disclosure relates to a sensor fusion system and a method of managing a track in the sensor fusion system.

### BACKGROUND

A large number of sensors may be applied to a vehicle in order to control autonomous driving a vehicle in a complex environment. As the number of sensors applied to a vehicle increases, the accuracy and reliability of detection of an object around the vehicle may increase. However, the number of pieces of information about a false object may also increase.

Further, addition of a new sensor to a vehicle greatly may increase the total number of tracks to be managed in a sensor fusion system of the vehicle.

Therefore, as the number of sensor fusion tracks increases, technology for managing the life cycle of a track (e.g. maintenance and/or destruction) may be applicable to secure the performance of a sensor fusion system.

For example, as the number of false tracks increases, the probability of fusion between false tracks and normal tracks increases, which may adversely affect the performance of the sensor fusion system. Therefore, it is desirable to appropriately manage the life cycle of a track in order to remove false tracks.

Meanwhile, if the number of tracks increases, the number of transmittable tracks may be limited due to network overload, and the amount of computation of the sensor fusion system may also increase.

In order to manage a network, it may be desirable to prioritize sensor fusion tracks and to output sensor fusion tracks having higher priorities.

Further, increase in the amount of computation is closely related to the performance of the sensor fusion system. Therefore, it may be desirable to reduce or minimize the number of false tracks in order to reduce the number of tracks to be managed.

Therefore, a life cycle of a track may be managed based on the number of times in which an object recognized by an existing track is determined to be distinct from an object recognized by a new track created by sensors.

However, such approach of managing the life cycle of a track may not be capable of eliminating false tracks.

For example, if false tracks for a specific location are continuously output through a single sensor, such approach of managing the life cycle of a track may not be capable of eliminating the false tracks.

Meanwhile, a false track may mean a track that causes misrecognition of objects. However, the meaning of the false track may be different for each system of a vehicle.

For example, in a static object recognition system of a vehicle, a dynamic object may be an object of non-interest. Thus, a track indicating a dynamic object may be a false track in the static object recognition system. In addition, in a dynamic object recognition system of a vehicle, a static object may be an object of non-interest. Thus, a track indicating a static object may be a false track in the dynamic object recognition system.

In some cases, a track corresponding to a false track of each system may be managed so as to be continuously maintained.

In addition, sensor fusion tracks may be prioritized such that a track indicating an object located close to a host vehicle or a host vehicle lane has a high priority. In this case, even if the track indicating the object located close to the host vehicle or the host vehicle lane is actually a false track or an unreliable track, the corresponding track may be managed so as to be maintained. For example, if the host vehicle lane is a first lane, a high priority may be assigned to a track indicating a center guardrail, and if the host vehicle lane is a last lane, a high priority may be assigned to a track indicating roadside trees. The track having a high priority may be output and managed so as to be continuously maintained.

Meanwhile, if the life cycle of a track is not appropriately managed, the performance of the sensor fusion system may be degraded, which may adversely affect a vehicle system associated with the sensor fusion system.

Therefore, there is a need to develop novel technology for managing a track in a sensor fusion system of a vehicle.

### SUMMARY

According to the present disclosure, a method may comprise: detecting, based on sensing information from one or more sensors of a vehicle, track information associated with an object; and determining a management index of the track information based on at least one of: a maintenance time of the track information associated with an amount of time the object has been tracked, an accuracy of information from the one or more sensors, or a risk of collision between the vehicle and the object.

The method, wherein the determining the management index is based on the track information being created in association with a prior track information previously created, wherein the track information is created based on updated sensing information of the one or more sensors within an update period of time.

The method, wherein the determining the management index may comprise determining a first management index value based on the maintenance time of the track information, and wherein the maintenance time of the track information may comprise a number of updates made to first original track information associated with the object.

The method, wherein the first management index value increases as the number of updates increases. The method, wherein the determining the management index may comprise determining a second management index value based on a predetermined value so that the second management index value is inversely proportional to the accuracy of the information from the one or more sensors.

The method, wherein the determining the second management index value may comprise, based on classification information of the track information not being included in predetermined classification information, subtracting a constant from the predetermined value to determine the second management index value.

The method, wherein the determining the second management index value may comprise, based on movement information of the object indicating a stopped state, subtracting a constant from the predetermined value to determine the second management index value.

The method, wherein the determining the management index may comprise determining a third management index value based on the risk of collision, and wherein the risk of collision is determined based on at least one of: a distance between the vehicle and the object, or a predicted time remaining until the vehicle collides with the object.

The method, wherein the third management index value increases as the distance between the vehicle and the object decreases, or wherein the third management index value increases as the predicted time to the collision decreases. The method, may further comprise determining, based on the track information being first original track information, that a value of the management index is a predetermined initial value.

The method, may further comprise reducing a value of the management index by a predetermined value based on absence of updated sensing information from the one or more sensing devices within an update period of time. The method, may further comprise: outputting, based on the management index, a signal to control operation of the vehicle.

According to the present disclosure, an apparatus may comprise: an interface configured to receive sensing information from one or more sensors of a vehicle; and a processor operatively connected to the interface, wherein the processor is configured to: detect, based on the sensing information, track information associated with an object; and determine a management index of the track information based on at least one of: a maintenance time of the track information associated with an amount of time the object has been tracked, an accuracy of information from the one or more sensors, or a risk of collision between the vehicle and the object.

The apparatus, wherein the processor is further configured to determine the management index based on the track information being created in association with a prior track information previously created, wherein the track information is created based on updated sensing information of the one or more sensors within an update period of time.

The apparatus, wherein the processor is further configured to determine a first management index value based on the maintenance time of the track information, and wherein the maintenance time of the track information may comprise a number of updates made to a first original track information associated with the object.

The apparatus, wherein the first management index value increases as the number of updates increases. The apparatus, wherein the processor is further configured to determine a second management index value based on a predetermined value so that the second management index value is inversely proportional to the accuracy of the information from the one or more sensors.

The apparatus, wherein the processor is further configured to, based on classification information of the track information not being included in predetermined classification information, subtract a constant from the predetermined value to determine the second management index value.

The apparatus, wherein the processor is further configured to, based on movement information of the object indicating a stopped state, subtract a constant from the predetermined value to determine the second management index value.

The apparatus, wherein the processor is further configured to determine a third management index value based on the risk of collision, and wherein the risk of collision is determined based on at least one of: a distance between the vehicle and the object, or a predicted time remaining until the vehicle collides with the object.

### BRIEF DESCRIPTION OF THE DRAWINGS

The accompanying drawings, which are included to provide a further understanding of the disclosure and are incorporated in and constitute a part of this application, show example(s) of the disclosure and together with the description serve to explain the principle of the disclosure. In the drawings:

FIG. 1 shows an example of a sensor fusion system of a vehicle according to an example;

FIG. 2 shows an example of an operation of a sensor fusion system according to an example;

FIG. 3 shows an example of an operation of a sensor fusion system according to an example; and

FIG. 4 shows an example of a situation in which a management index of a track is determined during travel of the vehicle according to an example.

### DETAILED DESCRIPTION

Like reference numerals refer to like elements throughout the specification. It is to be understood that not all elements of examples are described herein, and general contents or redundant contents of the examples in the art to which the present disclosure pertains will be omitted. Terms used herein such as “unit”, “module”, and “device” may be implemented by hardware or software. In some examples, a plurality of units, modules, or devices may be implemented as one component, or a single unit, module, or device may include a plurality of components.

Throughout the specification, if a part is referred to as being “connected” to another part, it is to be understood that it includes not only direct connection but also indirect connection, and the indirect connection includes connection via a wireless communication network.

Further, if a part is referred to as “including” or “having” another part, it is to be understood that it may further include other components, not excluding other components unless otherwise specifically indicated.

Terms such as “first”, “second”, and the like are used to distinguish one element from another element, and the elements are not limited by the above-described terms.

Unless the context clearly indicates otherwise, the singular forms include the plural forms.

In steps, identification codes are used for convenience of description and do not describe the order of the steps, and steps may be performed differently from the stated order unless explicitly stated in the context.

Examples of the present disclosure may provide a multi-sensor fusion track management index indicating the accuracy and/or importance (alternatively referred to as interest degree) of track information based on information involved in creation and/or maintenance of a track (e.g., a continuous representation or path of an object's movement and state over a period of time) for an object around a vehicle.

The accuracy information used to determine the management index may include an update state of sensor data acquired through a sensing device of the vehicle and/or uncertainty of track physical information determined based on the sensor data. For example, the uncertainty of track physical information may be a value based on the accuracy of output information of a sensing device used for track creation, and the accuracy of the output information of the sensing device may be a predetermined value corresponding to each sensing device according to preliminary performance evaluation of each sensing device.

The importance information used to determine the management index may include a position of the created track and a time to collision (TTC) between the vehicle and a target.

For example, the accuracy of the track information may be determined based on track maintenance time information and the uncertainty of the track physical information.

For example, the importance (alternatively referred to as interest degree) of track information, that is, the importance (alternatively referred to as interest degree) of a track for an object around the vehicle (a track around the vehicle) may be determined based on the relative position of the track to the surrounding object and a time to collision with a target.

The management index may be determined based on both previous time point information (alternatively referred to as information containing a previous state) and current time point information (alternatively referred to as current state information).

For example, the information containing a previous state may include a maintenance time of the track and/or uncertainty of the track.

For example, the current state information may include the types and performance of fused sensors and the collision risk of a vehicle 1 (e.g. a location and/or a time to collision).

Hereinafter, the operation principle and examples of the present disclosure will be described with reference to the accompanying drawings.

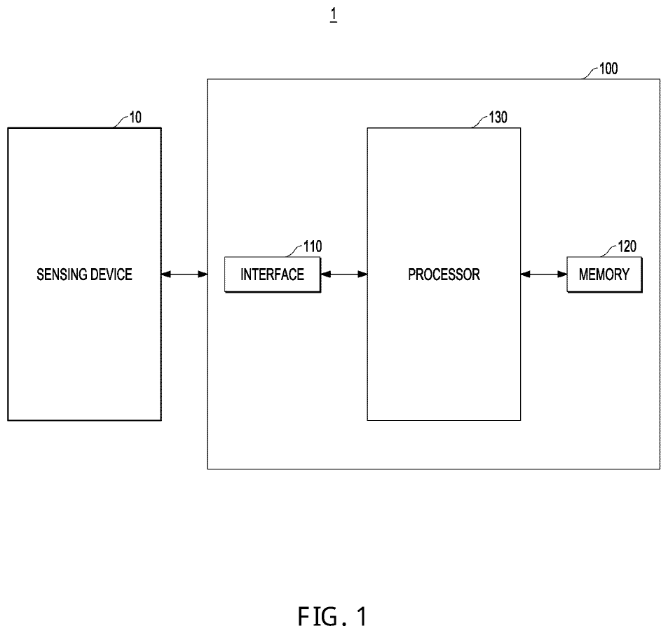

FIG. 1 shows an example of a sensor fusion system of a vehicle according to an example.

Referring to FIG. 1, a vehicle 1 may include a sensing device 10 and a sensor fusion system 100.

The sensing device 10 may include one or more devices (e.g., sensors) capable of acquiring information about an object (alternatively referred to as a target) located around the vehicle 1.

The sensing device 10 may include a LiDAR sensor (not shown), a radar sensor (not shown), and/or a camera (not shown).

One LiDAR sensor or a plurality of LiDAR sensors may be mounted in the vehicle 1, and may radiate a laser pulse toward a region around the vehicle 1 to generate LiDAR data, i.e. point cloud data.

The radar sensor may detect an object around the vehicle 1.

The camera may acquire image data of the surroundings of the vehicle 1.

The sensor fusion system 100 may include an interface 110, a memory 120, and/or a processor 130.

The interface 110 may transmit a command or data input from another device of the vehicle 1, e.g. the sensing device 10, or a user to another component of the sensor fusion system 100, or may output a command or data received from another component of the sensor fusion system 100 to another device of the vehicle 1.

The interface 110 may include a communication module (not shown) to communicate with another device of the vehicle 1, e.g. the sensing device 10.

For example, the communication module may include a communication module enabling communication between devices of the vehicle 1, e.g. controller area network (CAN) communication and/or local interconnect network (LIN) communication, through a vehicle communication network. In addition, the communication module may include a wired communication module (e.g. a power line communication module) and/or a wireless communication module (e.g. a cellular communication module, a Wi-Fi communication module, a short-range wireless communication module, and/or a global navigation satellite system (GNSS) communication module).

The memory 120 may store various data used by at least one component of the sensor fusion system 100, e.g. a software program, and input data and/or output data for a command related thereto.

The memory 120 may include a non-volatile memory such as a cache, read only memory (ROM), programmable ROM (PROM), erasable programmable ROM (EPROM), electrically erasable programmable ROM (EEPROM), and/or flash memory, and/or a volatile memory such as random access memory (RAM).

The processor 130 (alternatively referred to as a control circuit or a controller) may control at least one other component of the sensor fusion system 100 (e.g. a hardware component (e.g. the interface 110 and/or the memory 120) and/or a software component (the software program)), and may perform various data processing and calculations.

The processor 130 may create a track for an object (alternatively referred to as a target) around the vehicle 1 based on sensing information received from the sensing device 10.

For example, the track may include a position estimation value corresponding to an object in order to track the object. For example, the track may include a sensor fusion track created based on sensing information of a plurality of sensing devices.

The processor 130 may determine a track management index, which is an index indicating the accuracy and/or importance (alternatively referred to as interest degree) of the track.

The accuracy of the track may be determined based on a track maintenance time for the object and/or the uncertainty of the sensing information fused based on the data of the sensing device 10.

If the track maintenance time is long, this means that the sensor fusion system 100 has tracked the object for a long time. In this case, the probability that the corresponding object is not a false object, i.e. a meaningless object, is high. Accordingly, the track maintenance time for the object may be considered in determining accuracy in the track management index.

In addition or alternative, as will be described later, the uncertainty of the fused sensing information is determined based on the uncertainty of estimated physical information and object property information. The accuracy of physical information of the vehicle 1 (the longitudinal position and/or lateral position of the vehicle 1 and the longitudinal speed and/or lateral speed of the vehicle 1) may be influenced by a combination of the fused sensing information and an update time of the sensing information. Accordingly, the uncertainty of the fused sensing information may be considered in determining accuracy in the track management index.

The importance of the track may be determined based on the risk of collision between the vehicle 1 and the object.

The closer the distance between the vehicle 1 and the object and/or the shorter the time to collision between the vehicle 1 and the object, the higher the risk of collision between the vehicle 1 and the object. Such a collision risk may be an important consideration factor for safe control of the vehicle 1. Accordingly, the risk of collision between the vehicle 1 and the object may be considered in determining importance in the track management index.

As described above, the processor 130 may determine the track management index based on the track maintenance time for the object, the uncertainty of the sensing information fused based on the data of the sensing device 10, and/or the risk of collision between the vehicle 1 and the object.

For example, the track management index may be determined using Equation 1 below.

Management Index=ω₁*AgeScore+ω₂*SensorCombinationScore+ω₃*PositionScore [Equation 1]

Here, AgeScore represents a first management index based on the track maintenance time for the object, SensorCombinationScore represents a second management index based on the accuracy of the output information of the sensing device 10 (alternatively referred to as the uncertainty of the sensing information fused based on the data of the sensing device 10), PositionScore represents a third management index based on the risk of collision between the vehicle 1 and the object, w₁ represents a predetermined first weight, w₂ represents a predetermined second weight, and w₃ represents a predetermined third weight.

In Equation 1, the range of Management Index may include a range between 0 and 100. In addition, the range of AgeScore may include a range between 0 and 100. In addition or alternative, the range of SensorCombinationScore may include a range between 0 and 100. In addition or alternative, the range of PositionScore may include a range between 0 and 100. In addition or alternative, each of the first, second, and third weights w₁, w₂, and w₃ may be set in advance such that Management Index is in the range of 0 to 100, and a sum of w₁, w₂, and w₃ may be 1 (w₁+w₂+w₃=1).

The first management index AgeScore based on the track maintenance time in Equation 1 may be determined using Equation 2 below.

AgeScore=C₁*UpdateAge+C₂ [Equation 2]

Here, C₁ represents a first constant, C₂ represents a second constant, and UpdateAge represents the number of updates of the track (alternatively referred to as the number of times by which the sensing information (or the fused sensing information) is updated in order to update and maintain the track).

UpdateAge in Equation 2 may represent the number of updates of the track for the object during a maintenance period of the track from initial creation thereof to destruction thereof.

For example, if there is updated sensing information of the sensing device 10 at a predetermined update period of sensor fusion logic, the track for the object is created, i.e. updated, in association with the track for the object created in the previous step based on the updated sensing information. The number of updates until the current step, i.e. until creation of the track, may be the number of updates of the track in Equation 2.

C₁ and C₂ in Equation 2 may be predetermined values.

According to Equation 2, it may be seen that the value of the first management index becomes larger as the number of updates of the track increases.

The second management index SensorCombinationScore based on the accuracy of the output information of the sensing device 10 (alternatively referred to as the uncertainty of the fused sensing information) in Equation 1 may be determined using Equation 3 below.

$$SensorCombinationScore = \frac{{C}_{3}}{{\sum }_{n = 1}^{4} Covariance of physical value ( n )} - {C}_{4} * ( {Φ}_{1} ( classification ) + {Φ}_{2} ( moving flag ) ) \qquad [ Equation 3 ]$$

Here, Φ₁(classification) represents a value obtained from Condition 1 below, Φ₂(moving flag) represents a value obtained from Condition 2 below, Covariance of physical value represents an index indicating the uncertainty of a physical value of the track, C₃ represents a third constant, C₄ represents a fourth constant, and n represents an integer.

In Equation 3, C₃ and C₄ may be predetermined values.

n may indicate a physical value of the track.

For example, if the physical value of the track includes the longitudinal position, the lateral position, the longitudinal speed, and/or the lateral speed of the track, Covariance of physical value (n=1) may represent the uncertainty of the longitudinal position of the track, Covariance of physical value (n=2) may represent the uncertainty of the lateral position of the track, Covariance of physical value (n=3) may represent the uncertainty of the longitudinal speed of the track, and Covariance of physical value (n=4) may represent the uncertainty of the lateral speed of the track.

Each of Covariance of physical value (1), Covariance of physical value (2), Covariance of physical value (3), and Covariance of physical value (4) may be determined based on the sensing device used to create the track.

Each of Covariance of physical value (1) to Covariance of physical value (4) may be determined and/or updated according to update of the state of the track and the output information of the sensing device 10.

Each of the sensing devices 10 used to create the track may have accuracy of output information thereof, and accordingly, as the accuracy of the output information of the sensing device 10 decreases, each of Covariance of physical value (1) to Covariance of physical value (4) may be determined to be a higher value.

For example, Covariance of physical value (1) to Covariance of physical value (4) obtained through preliminary performance evaluation may be previously assigned to each of the sensing devices 10 outputting sensing information used for creation of the track.

It may be said that the accuracy of output information of a sensing device having a low performance evaluation score is lower than that of a sensing device having a high performance evaluation score. Accordingly, Covariance of physical value (1) to Covariance of physical value (4) assigned to a sensing device having a low performance evaluation score may be higher than those assigned to a sensing device having a high performance evaluation score.

For example, if sensing information output from a plurality of sensing devices is used for creation of the track, the final value of each of Covariance of physical value (1) to Covariance of physical value (4) may be determined using a value obtained by summing values assigned to the plurality of sensing devices, a value obtained by averaging the assigned values, or a value obtained by summing values obtained by applying predetermined different weights to the assigned values.

In addition or alternative, each of Covariance of physical value (1) to Covariance of physical value (4) may be updated whenever output information of a corresponding sensing device is updated.

Meanwhile, if track classification information is inaccurate, this means that the output performance of a corresponding sensing device is low, and accordingly, the value of Φ₁(classification) may be considered in determining SensorCombinationScore, as shown in Equation 3.

For example, Condition 1 below may be set in advance for Equation 3 such that, if the track classification information is inaccurate and thus is determined to be “unknown”, i.e. if the classification information is not included in predetermined classification information, 1 is assigned to Φ₁(classification) and if the classification information is accurate, i.e. if the classification information is included in the predetermined classification information, 0 is assigned to Φ₁(classification).

$${Φ}_{1} ( classification ) = \{ \begin{matrix}1 , & if classification = unknown \\ 0 , & otherwise\end{matrix} \qquad 〈 Condition 1 〉$$

For example, the predetermined classification information may include a person, a vehicle, a building, and/or a tree.

In addition or alternative, in general, if the object is in a stopped state, the output performance of the sensing device 10 used to control travel of the vehicle 1 is lower than if the object is moving. Accordingly, as shown in Equation 3, the value of Φ₂(moving flag) may be considered in determining the second management index.

For example, Condition 2 below may be set in advance for Equation 3 such that, if object movement property information corresponds to a stopped state, i.e. if the object is a stopped object, 1 is assigned to Φ₂(moving flag) and if the object movement property information corresponds to a moving state, i.e. if the object is a moving object, 0 is assigned to Φ₂(moving flag).

$${Φ}_{2} ( moving flag ) = \{ \begin{matrix}1 , & if moving flag = stopped \\ 0 , & otherwise\end{matrix} \qquad 〈 Condition 2 〉$$

According to Equation 3, SensorCombinationScore may be determined in consideration of the characteristics that the output accuracy of the sensing device is influenced by the accuracy of the output information of the sensing device (alternatively referred to as the uncertainty of the physical value of the track), the track classification information, and/or the object movement property information indicated by the track.

For example, the value of SensorCombinationScore is inversely proportional to the accuracy of the output information of the sensing device 10, and is determined in consideration of the characteristics that the output performance of the sensing device is lowered if the classification information is inaccurate or if the object movement property information corresponds to a stopped state.

The third management index PositionScore based on the risk of collision between the vehicle 1 and the object in Equation 1 may be determined using Equation 4 below.

PositionScore=ω_{P}_{₁}*LongPosScore+ω_{P}_{₂}*LatPosScore+ω_{P}_{₃}*TTCScore [Equation 4]

Here, LongPosScore represents a predetermined value corresponding to a longitudinal distance between the vehicle 1 and the object indicated by the track, LatPosScore represents a predetermined value corresponding to a lateral distance between the vehicle 1 and the object indicated by the track, TTCScore represents a predetermined value corresponding to a time to collision between the vehicle 1 and the object, wₚ₁ represents a fourth weight, wₚ₂ represents a fifth weight, and wₚ₃ represents a sixth weight. A sum of wₚ₁, wₚ₂, and wₚ₃ is 1 (wₚ₁+wₚ₂+wₚ₃=1).

The values of wₚ₁, wₚ₂, and wₚ₃ in Equation 4 may be predetermined values.

Each of LongPosScore and LatPosScore is a value determined depending on the position of the track. A value corresponding to each position of the track may be set in advance such that the value increases as the distance between the object indicated by the track and the vehicle 1 decreases.

TTCScore is a value determined depending on a time to collision between the vehicle 1 and the object indicated by the track. If the time to collision between the vehicle 1 and the object indicated by the track decreases, this means that the importance and interest degree of the track increase. Accordingly, a value corresponding to each time to collision may be set in advance such that TTCScore has a higher value as the time to collision decreases.

In Equation 1, each of the first weight w₁ and the second weight w₂ may be a weight of an index based on the accuracy of track information, and the third weight w₃ may be a weight of an index based on the importance (and interest degree) of the track.

Each of the first weight w₁, the second weight w₂, and the third weight w₃ is set based on both the accuracy of the track and the importance (and interest degree) of the track in generating the track management index. In this case, the proportion occupied by the accuracy may be larger.

For example, in generating the track management index, the value of each of the first weight w₁, the second weight w₂, and the third weight w₃ may be set in advance such that the ratio of the accuracy of the track information to the importance (and interest degree) of the track is 6:4.

Since the second management index SensorCombinationScore is determined based on the accuracy of the actually used output information of the sensing device 10 and whether the output information of the sensing device 10 has been updated, the second management index SensorCombinationScore and the first management index AgeScore based on the track maintenance time for the object may have an overlapping meaning. Accordingly, the first weight w₁ and the second weight w₂ may be set in advance such that the ratio of w₁ to w₂ is 1:2.

For example, the track management index is generated in consideration of the first management index AgeScore, which most clearly reflects the maintenance of the track. However, the second weight w₂ may have a higher value than the first weight w₁ so that the weight for the uncertainty of the track, which is determined in consideration of complex situations, increases. The value of each of the first weight w₁ and the second weight w₂ may be set in advance.

For example, the first weight w₁, the second weight w₂, and the third weight w₃ may be set in advance to 0.2, 0.4, and 0.4, respectively.

Meanwhile, the values of the weights, i.e. the first weight w₁, the second weight w₂, and the third weight w₃, may vary depending on a method of utilizing the management index.

Whether to maintain and/or output the sensor fusion track is determined and managed depending on the management index. However, a method of managing the sensor fusion track may be changed depending on requirements of other functions of the vehicle 1 using the sensor fusion track.

For example, each of the first weight w₁ and the second weight w₂ may be set to have a higher value than the third weight w₃ so that the proportion occupied by the accuracy of the track increases. In another example, if functions using the sensor fusion track need a management index in which the importance (and interest degree) of the track occupies a larger proportion, the third weight w₃ may be set to have a higher value than the first weight w₁ and the second weight w₂.

The processor 130 may determine whether to maintain and/or create a track to be finally output depending on the determined value of the management index.

For example, if redundant tracks are created for the same object, the value of the management index may be used as a value for determining the output priority of a track and/or the output priority of a final sensor fusion track.

For example, the processor 130 may identify a management index value before outputting a track, and may not output the track if the management index value of the track is equal to or less than a predetermined threshold value (e.g. 30).

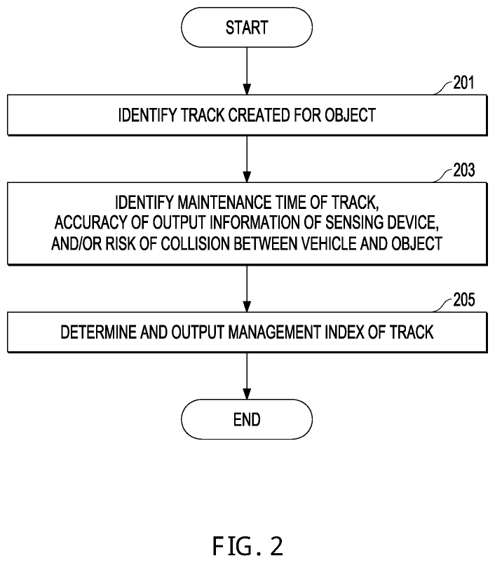

FIG. 2 shows an example of an operation of the sensor fusion system 100 (and/or the processor 130) according to an example.

Referring to FIG. 2, the sensor fusion system 100 may identify a track generated for an object based on sensing information received through the sensing device 10 of the vehicle 1 (operation 201).

The number of sensing devices 10 providing the sensing information used to create the track may be one or two or more, and the track may be a sensor fusion track.

The sensor fusion system 100 may identify the maintenance time of the track, the accuracy of the output information of the sensing device 10, and/or the risk of collision between the vehicle and the object (operation 203).

Operation 203 may be performed if the track created for the object is a track created in association with a track created in a previous step based on updated sensing information at a predetermined update period of the sensor fusion logic of the sensor fusion system 100.

The sensor fusion system 100 may determine and output a management index of the track based on the maintenance time of the track, the accuracy of the output information of the sensing device 10 providing the sensing information, and/or the risk of collision between the vehicle and the object (operation 205).

The sensor fusion system 100 may determine the first management index value based on the maintenance time of the track using Equation 2 above.

For example, the maintenance time of the track may include the number of updates of the track for the object from the first original track for the object to creation of the track, and the first management index value may have a larger value as the number of updates of the track increases.

The sensor fusion system 100 may determine the second management index value using Equation 3 above based on a predetermined value so that the second management index value is inversely proportional to the accuracy of the output information of the sensing device 10 providing the sensing information used to create the track.

For example, the sensor fusion system 100 may determine the second management index value based on the track classification information and/or the track movement property information in addition or alternative to a predetermine value so that the second management index value is inversely proportional to the accuracy of the output information of the sensing device 10 providing the sensing information used to create the track.

The sensor fusion system 100 may determine the third management index value of the track using Equation 4 based on the risk of collision between the vehicle 1 and the object.

For example, the risk of collision between the vehicle 1 and the object may be determined based on a distance between the vehicle 1 and the object and/or a time to collision between the vehicle 1 and the object.

For example, the third management index value may have a higher value as the distance between the vehicle 1 and the object decreases and may have a higher value as the time to collision between the vehicle 1 and the object decreases.

Meanwhile, if the track in operation 201 is a first original track, the sensor fusion system 100 may determine a predetermined initial value to be a management index of the track.

In addition or alternative, if the track in operation 201 is a track created in a previous step and there is no updated sensing information received at a predetermined update period of the sensor fusion logic, the sensor fusion system 100 may reduce the previously determined management index of the track by a predetermined value.

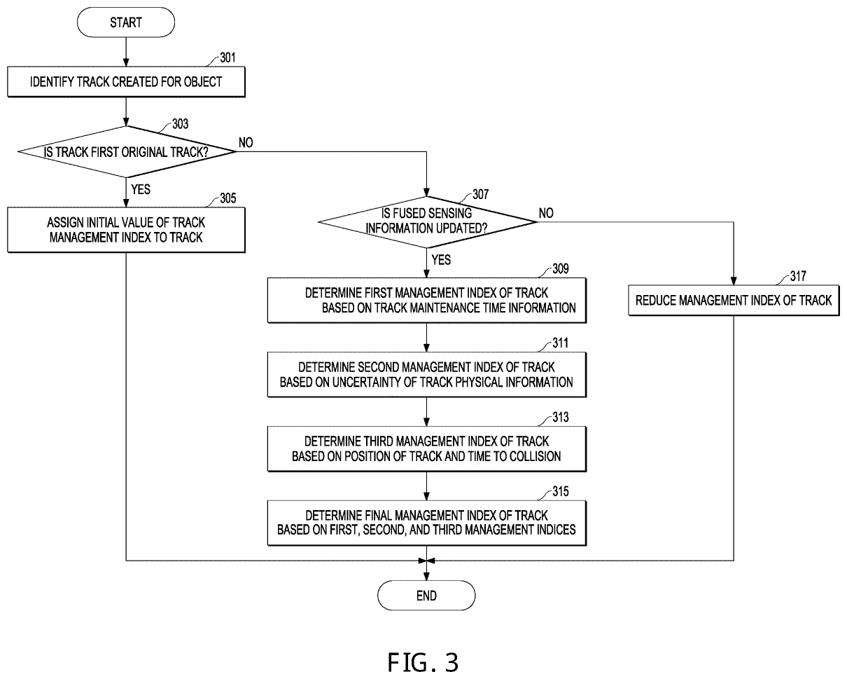

FIG. 3 shows an example of an operation of the sensor fusion system 100 (and/or the processor 130) according to an example.

Referring to FIG. 3, the sensor fusion system 100 may identify a track generated for an object (operation 301).

The sensor fusion system 100 may identify a track for a first object located around the vehicle 1 generated based on the sensing information received through the sensing device 10.

The sensor fusion system 100 may determine whether the track is a first original track (operation 303).

For example, if there is a track for the first object created in the previous step (T-1 step) (hereinafter referred to as a previous track), if a track for the first object is created, i.e. updated and maintained, in association with the previous track and/or through track update operation at the current step (T step), the sensor fusion system 100 may determine that the track is not the first original track.

If the track is the first original track, the sensor fusion system 100 may perform operation 305, and if the track is not the first original track, the sensor fusion system 100 may perform operation 307.

The sensor fusion system 100 may assign a predetermined initial value of the track management index to the track (operation 305).

The sensor fusion system 100 may determine whether to update the fused sensing information (operation 307).

For example, assuming that the update period of the sensor fusion logic is set in advance to 1T (T is an integer) and the sensing information output period of the sensing device 10 is set in advance to 2T, the sensor fusion system 100 may not acquire updated sensing information to be used for update of the existing track at the update period of the sensor fusion logic. In this state, the sensor fusion system 100 may determine that the fused sensing information for update of the track has not been updated.

In the state in which updated sensing information to be used for update of the existing track is acquired at the update period of the sensor fusion logic, the sensor fusion system 100 may determine that the fused sensing information for update of the track has been updated.

If the fused sensing information is updated, the sensor fusion system 100 may perform operation 309, and if the fused sensing information is not updated, the sensor fusion system 100 may perform operation 317.

The sensor fusion system 100 may determine a first management index of the track based on track maintenance time information (operation 309).

For example, the first management index of the track based on the track maintenance time information may be determined using Equation 2 above.

The sensor fusion system 100 may determine a second management index of the track based on the uncertainty of track physical information (operation 311).

For example, the uncertainty of the track physical information may be a value based on the accuracy of the output information of the sensing device 10 providing sensing information used to create the track.

For example, the second management index of the track based on the uncertainty of the track physical information may be determined using Equation 3 above.

The sensor fusion system 100 may determine a third management index of the track based on the position of the track and a time to collision (operation 313).

For example, the third management index of the track based on the position of the track and the time to collision may be determined using Equation 4 above.

The sensor fusion system 100 may determine a final management index of the track based on the first management index, the second management index, and the third management index (operation 315).

For example, the sensor fusion system 100 may determine the management index of the track (Management Index) determined using Equation 1 above to be the final management index.

The sensor fusion system 100 may reduce the management index of the track (operation 317).

For example, the sensor fusion system 100 may reduce the existing management index of the track by a predetermined value (or rate).

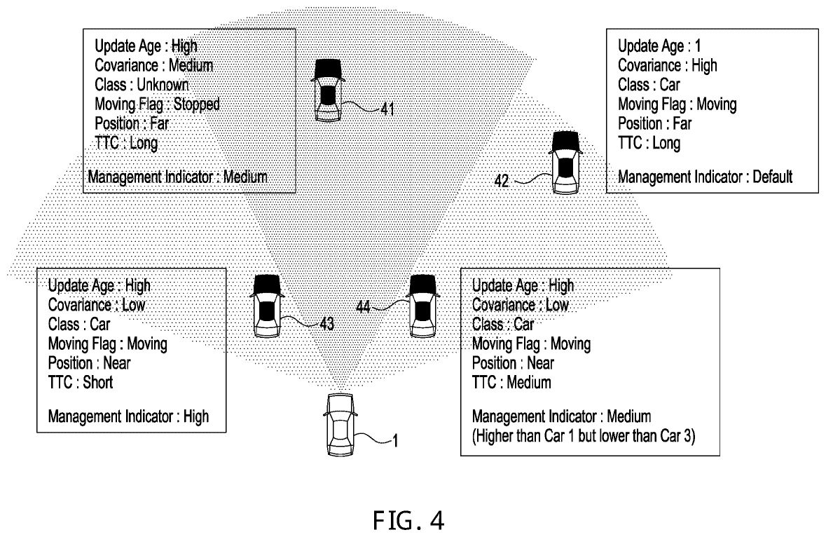

FIG. 4 shows an example of a situation in which the management index of the track is determined during travel of the vehicle 1 according to an example.

Referring to FIG. 4, it is assumed that a first vehicle 41, a second vehicle 42, a third vehicle 43, and a fourth vehicle 44 are present around the vehicle 1.

It is assumed that Update Age of the track for the first vehicle 41 (UpdateAge in Equation 2) is High, Covariance (Σₙ₌₁⁴ Covariance of pysical value (n) in Equation 3) is Medium, Class (classification in Equation 3, i.e. classification information) is Unknown, Moving Flag (moving flag in Equation 3, i.e. information about a stopped state or a moving state of the object) is Stopped, Position (longitudinal and lateral distances between the vehicle 1 and the object in Equation 4) is Far, and TTC (time to collision between the vehicle 1 and the object in Equation 4) is Long.

In addition or alternative, it is assumed that Update Age of the track for the second vehicle 42 is 1, Covariance is High, Class is Car, Moving Flag is Moving, Position is Far, and TTC is Long.

In addition or alternative, it is assumed that Update Age of the track for the third vehicle 43 is High, Covariance is Low, Class is Car, Moving Flag is Moving, Position is Near, and TTC is Short.

In addition or alternative, it is assumed that Update Age of the track for the fourth vehicle 44 is High, Covariance is Low, Class is Car, Moving Flag is Moving, Position is Near, and TTC is Medium.

In the above situation, since the track of the first vehicle 41 is maintained for a long time and the uncertainty of the fused sensing information is medium, the accuracy of the track, i.e. the management index related to the estimated information, is high, but the risk of collision between the vehicle 1 and the object, which is a management index related to the importance (or interest degree), is low.

Accordingly, according to the above-described examples, the finally determined management index of the track of the first vehicle 41 (Management Indicator) may have a medium value (Medium).

Since Update Age of the track of the second vehicle 42 is 1, it may be seen that the track of the second vehicle 42 is a first original track.

Accordingly, according to the above-described examples, the finally determined management index of the track of the second vehicle 42 (Management Indicator) may have an initial value (Default).

It may be seen that information other than TTC about the track of the third vehicle 43 and information other than TTC about the track of the fourth vehicle 44 are similar to each other and that TTC of the track of the third vehicle 43 is shorter than that of the track of the fourth vehicle 44.

Accordingly, according to the above-described examples, the track of the third vehicle 43 may have a higher management index value (Management Indicator) than the track of the fourth vehicle 44. In addition, according to the above-described examples, the track of the fourth vehicle 44 may have a management index value (Management Indicator) higher than that of the track of the first vehicle 41 but lower than that of the track of the third vehicle 43.

Accordingly, the present disclosure is directed to a sensor fusion system and a method of managing a track in the sensor fusion system that substantially obviate one or more problems due to limitations and disadvantages of the related art.

According to an example of the present disclosure, there may be provided a sensor fusion system and a method of managing a track in the sensor fusion system, which may provide a sensor fusion track management index for improving efficiency of sensor fusion track management.

For example, a sensor fusion system and a method of managing a track in the sensor fusion system of the present disclosure may improve track life cycle management performance, which may greatly affect the accuracy and reliability of a sensor fusion track.

For example, a sensor fusion system and a method of managing a track in the sensor fusion system of the present disclosure may provide a quantitative sensor fusion track management index to determine the output priority of a sensor fusion track as an associated system operating in association with operation of the sensor fusion system.

For example, a sensor fusion system and a method of managing a track in the sensor fusion system of the present disclosure may provide a track management index determined based on a lifetime of the track, the number of fused sensors, the uncertainty of track information, the position of a target, and/or the risk of collision between a vehicle and the target.

Additional advantages, objects, and features of the disclosure will be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, a method of managing a track in a sensor fusion system comprises identifying a track created for an object based on sensing information received through one or more sensing devices of a host vehicle and determining and outputting a management index of the track based on at least one of a maintenance time of the track, the accuracy of output information of the one or more sensing devices, or the risk of collision between the vehicle and the object.

Determining the management index of the track may be performed if the track is created in association with a track created in a previous step based on updated sensing information of the one or more sensing devices at a predetermined update period of sensor fusion logic.

Determining the management index of the track may include determining a first management index value based on the maintenance time of the track, and the maintenance time of the track may include a number of updates of the track for the object from a first original track for the object to creation of the track.

The first management index value may have a larger value as the number of updates of the track increases.

Determining the management index of the track may include determining a second management index value based on a predetermined value so that the second management index value is inversely proportional to the accuracy of the output information of the one or more sensing devices.

Determining the second management index value may further include, if classification information of the track is not included in predetermined classification information, subtracting a predetermined constant from the predetermined value to determine the second management index value.

Determining the second management index value may further include, if movement property information of the object indicates a stopped state, further subtracting the predetermined constant from the predetermined value to determine the second management index value.

Determining the management index of the track may include determining a third management index value based on the risk of collision between the vehicle and the object, and the risk of collision may be determined based on at least one of a distance between the vehicle and the object or a time to collision between the vehicle and the object. The importance of the position of the object may be included in the risk of collision.

The third management index value may have a higher value as the distance between the vehicle and the object decreases and may have a higher value as the time to collision between the vehicle and the object decreases.

The method may further include determining, if the track is a first original track, the management index of the track to be a predetermined initial value.

The method may further include reducing the management index of the track by a predetermined value if the track is a track created in a previous step and there is no updated sensing information received through the one or more sensing devices at a predetermined update period of sensor fusion logic.

In another example of the present disclosure, a sensor fusion system includes an interface configured to receive sensing information through one or more sensing devices of a host vehicle and a processor communicatively or electrically connected to the interface, wherein the processor is configured to identify a track created for an object based on the sensing information and to determine and output a management index of the track based on at least one of a maintenance time of the track, the accuracy of output information of the one or more sensing devices, or the risk of collision between the vehicle and the object.

The processor may determine the management index of the track if the track is created in association with a track created in a previous step based on updated sensing information of the one or more sensing devices at a predetermined update period of sensor fusion logic.

The processor may be configured to determine a first management index value based on the maintenance time of the track, and the maintenance time of the track may include the number of updates of the track for the object from a first original track for the object to creation of the track.

The first management index value may have a larger value as the number of updates of the track increases.

The processor may be configured to determine a second management index value based on a predetermined value so that the second management index value is inversely proportional to the accuracy of the output information of the one or more sensing devices.

The processor may be further configured to, if classification information of the track is not included in predetermined classification information, subtract a predetermined constant from the predetermined value to determine the second management index value.

The processor may be further configured to, if movement property information of the object indicates a stopped state, further subtract the predetermined constant from the predetermined value to determine the second management index value.

The processor may be configured to determine a third management index value based on the risk of collision between the vehicle and the object, and the risk of collision may be determined based on at least one of a distance between the vehicle and the object or a time to collision between the vehicle and the object.

It is to be understood that both the foregoing general description and the following detailed description of the present disclosure are exemplary and explanatory and are intended to provide further explanation of the disclosure as claimed.

The above-described examples may be implemented as a recording medium storing an instruction executable by a computer. The instruction may be stored as program code, and may create a program module to perform operations of the disclosed examples when executed by a processor. The recording medium may be implemented as a computer-readable recording medium.

The computer-readable recording medium includes all types of recording media storing instructions that may be decoded by a computer. Examples thereof may include a read only memory (ROM), a random access memory (RAM), a magnetic tape, a magnetic disk, a flash memory, an optical data storage device, etc.

As is apparent from the above description, according to a sensor fusion system and a method of managing a track in the sensor fusion system according to an example of the present disclosure, it is possible to improve the efficiency of track number management and to reduce a calculation time required for control logic based on the track.

According to a sensor fusion system and a method of managing a track in the sensor fusion system according to an example of the present disclosure, it is possible to improve the output performance of a sensor fusion track.

For example, an autonomous driving function of a vehicle may include recognition, determination, and control. If determination and control are performed using a result of recognition, a management index of a track obtained based on the accuracy and importance of the track may be used as information for a sensor fusion track.

According to a sensor fusion system and a method of managing a track in the sensor fusion system according to an example of the present disclosure, it is possible to increase robustness and utilization of a management index of a track.

For example, according to a sensor fusion system and a method of managing a track in the sensor fusion system according to an example of the present disclosure, information about a track is utilized in a different way such that the information about the track may not be affected by change of a sensor group of a vehicle, i.e. a sensing device (e.g. addition of a new sensor, removal of an existing sensor, change in mounting position of a sensor, etc.).

For example, according to a sensor fusion system and a method of managing a track in the sensor fusion system according to an example of the present disclosure, even if a combination of sensors used in the sensor fusion system is changed, information, such as a maintenance time of the track, the uncertainty of the track, the position of the track, and/or a time to collision between a vehicle and an object indicated by the track, may have the same index.

As described above, the disclosed examples have been described with reference to the accompanying drawings. A person skilled in the art to which the present disclosure pertains will understand that the present disclosure may be implemented in a form different from that of the disclosed examples without changing the technical spirit or essential features of the present disclosure. The disclosed examples are illustrative and should not be restrictively construed.

What is claimed is:

1. A method comprising:
detecting, based on sensing information from one or more sensors of a vehicle, track information associated with an object; and
determining a management index of the track information based on at least one of:
a maintenance time of the track information associated with an amount of time the object has been tracked,
an accuracy of information from the one or more sensors, or
a risk of collision between the vehicle and the object.

2. The method of claim 1, wherein the determining the management index is based on the track information being created in association with a prior track information previously created, wherein the track information is created based on updated sensing information of the one or more sensors within an update period of time.

3. The method of claim 2, wherein the determining the management index comprises determining a first management index value based on the maintenance time of the track information, and
wherein the maintenance time of the track information comprises a number of updates made to first original track information associated with the object.

4. The method of claim 3, wherein the first management index value increases as the number of updates increases.

5. The method of claim 2, wherein the determining the management index comprises determining a second management index value based on a predetermined value so that the second management index value is inversely proportional to the accuracy of the information from the one or more sensors.

6. The method of claim 5, wherein the determining the second management index value comprises, based on classification information of the track information not being included in predetermined classification information, reducing the predetermined value by a constant to determine the second management index value.

7. The method of claim 5, wherein the determining the second management index value comprises, based on movement information of the object indicating a stopped state, reducing the predetermined value by a constant to determine the second management index value.

8. The method of claim 2, wherein the determining the management index comprises determining a third management index value based on the risk of collision, and
wherein the risk of collision is determined based on at least one of:
a distance between the vehicle and the object, or
a predicted time remaining until the vehicle collides with the object.

9. The method of claim 8, wherein the third management index value increases as the distance between the vehicle and the object decreases, or wherein the third management index value increases as the predicted time to the collision decreases.

10. The method of claim 1, further comprising determining, based on the track information being first original track information, that a value of the management index is a predetermined initial value.

11. The method of claim 1, further comprising reducing a value of the management index by a predetermined value based on absence of updated sensing information from the one or more sensing devices within an update period of time.

12. An apparatus comprising:
an interface configured to receive sensing information from one or more sensors of a vehicle; and
a processor operatively connected to the interface,
wherein the processor is configured to:
detect, based on the sensing information, track information associated with an object; and
determine a management index of the track information based on at least one of:
a maintenance time of the track information associated with an amount of time the object has been tracked,
an accuracy of information from the one or more sensors, or
a risk of collision between the vehicle and the object.

13. The apparatus of claim 12, wherein the processor is further configured to determine the management index based on the track information being created in association with a prior track information previously created, wherein the track information is created based on updated sensing information of the one or more sensors within an update period of time.

14. The apparatus of claim 13, wherein the processor is further configured to determine a first management index value based on the maintenance time of the track information, and
wherein the maintenance time of the track information comprises a number of updates made to a first original track information associated with the object.

15. The apparatus of claim 14, wherein the first management index value increases as the number of updates increases.

16. The apparatus of claim 13, wherein the processor is further configured to determine a second management index value based on a predetermined value so that the second management index value is inversely proportional to the accuracy of the information from the one or more sensors.

17. The apparatus of claim 16, wherein the processor is further configured to, based on classification information of the track information not being included in predetermined classification information, reduce the predetermined value by a constant to determine the second management index value.

18. The apparatus of claim 16, wherein the processor is further configured to, based on movement information of the object indicating a stopped state, reduce the predetermined value by a constant to determine the second management index value.

19. The apparatus of claim 13, wherein the processor is further configured to determine a third management index value based on the risk of collision, and
wherein the risk of collision is determined based on at least one of:
a distance between the vehicle and the object, or
a predicted time remaining until the vehicle collides with the object.

20. The method of claim 1, further comprising:
outputting, based on the management index, a signal to control operation of the vehicle.
